(19) United States
(12) Patent Application Publication
(10) Pub. No.: US 2005/0237859 A1
(43) Pub. Date: Oct. 27, 2005

(54) Muslim's portable prayer times calculator

(76) Inventor: Sammy M. Jibrin, Garland, TX (US)

Correspondence Address: Mircea Achiriloaie, 2415 Rebecca Lynn Way, Santa Clara, CA, 95050, US

(21) Appl. No.: 10/830,842

(22) Filed: Apr. 22, 2004

(51) Int. Cl. G04C 11/02; G04B 49/00; G04B 19/26

(52) U.S. Cl. 368/47

(57) ABSTRACT

A system is provided that accurately determines Muslim prayer times. From present date and clock data as well as location as determined by a GPS receiver the system calculates and communicates Muslim prayer times. Based on the GPS-detected location qibla may also be determined and conveyed.

### FIELD OF INVENTION

The invention relates to methods and devices for calculating Muslim religious service-times.

### BACKGROUND OF INVENTION

Prayer (salat) is a pillar of Islamic religious practice. Five daily prayers are required of at distinct times: dawn (fajr or subh), noon (zuhr), afternoon (asr), sunset (maghrib), and dusk (isha). Prayer typically involves standing, bowing, and prostrating facing a set direction known as qibla (towards kaaba, in the city of Mecca). The precise timing of each daily prayer depends on the position of the sun. Therefore even within the same country the timing of daily prayers differs depending on geographical position, date, and year. In communities inhabited by a substantial number of Muslims, people are informed of prayer times by a crier (muezzin) from a mosque who repeats a call to prayer (adhan).

Muslims who live relatively isolated within communities of different faiths need other arrangements for determining and remembering the appropriate daily prayer times and the direction of Mecca. Such arrangements can be particularly difficult for those who travel frequently and who need to determine the appropriate prayer times and qibla in unfamiliar locations. Part of the problem is that traditionally required prayer times change with location. Altering travel schedules or destinations, changing time zones, and shifting of daylight savings time may compound the difficulties. Accordingly, there is a current need for devices or methods useful for Muslims to accurately establish prayer times specific for their present location, help in determining qibla, and prompt users of the start of prayer times.

### SUMMARY OF INVENTION

The present invention relates to devices and methods for determining prayer times for Muslim religious services. In some aspects the invention is directed to computer readable media that comprises programs capable of implementing the invented methods. The invention may be embodied in portable devices, for example, in cellular telephones equipped with a Global Positioning System Receiver. In these embodiments, it is preferable that the cellular telephones are configured to communicated via common protocols such as GSM that enable a widespread functionality of the telephone features.

Date information necessary for determining prayer times is produced by a calendar. This information may be acquired automatically, although it may also be manually entered or adjusted. A clock produces present time information. The time may also be automatically acquired. For example, either or both the time and date may be synchronized to a wireless network. In some embodiments Muslim calendar information such as current date may be provided to the users.

The systems according to the present invention utilize a Global Positioning Satellite (GPS) detector for producing at least some of the needed information. Thus, the GPS detector produces longitude and latitude coordinates, which are useful to accurately calculate prayer times. The GPS detector may also produce altitude and time information, which may also be employed to calculate prayer times. The GPS can acquire the information automatically, i.e. without any action necessary by a user.

An automatic controller calculates prayer times based on the information made available. In some embodiments, approximations such as for altitude may be used in calculations. The controller typically needs the date, longitude and latitude coordinates. However, the controller may access altitude information for more accurate determinations. In addition to prayer times, the controller may also calculate the direction of Mecca from longitude and latitude coordinates. Some embodiments comprise a geomagnetic sensor for producing azimuth information, which helps in pointing out the direction of Mecca to users. In calculating prayer times the controller may also take into account preferences set by a user.

The calculated prayer times are communicated to users. A data output may communicate by any suitable means, and the information may be conveyed, for example, as a note on a device screen. Conveniently, prayer times may be communicated relative to the present local times. Preferably, when the present time matches a prayer time, an alarm is triggered to alert the user of the time to pray. Additionally, the invented devices may comprise an output for communicating the direction of Mecca to users. In those embodiments that comprise azimuth information, the users may be precisely informed of the Mecca direction, i.e. without any need for other information.

Devices that calculate prayer times can have additional functions. For example, they may be cellular telephones, and they may communicate via widely adopted communication protocols. In some embodiments, additional functions such as telephone features may be disabled for a defined period of time after the production of a prayer time signal.

The devices may also have an input for entering information such as a keypad. Information entered or adjusted may include preferences, time, or date. Overall, the invention provides means that have been hitherto impractical to instantly find out local prayer times with high accuracy.

### BRIEF DESCRIPTION OF DRAWINGS

FIG. 1 is a diagram of a prayer time determination method.

FIG. 2 is a diagram of a method for establishing the direction of Mecca.

### DETAILED DESCRIPTION OF PREFERRED EMBODIMENTS

Devices and methods are provided for accurately calculating traditional prayer times useful for those practicing the Muslim religion. A controller associated with the invented devices integrates information related to location and time from associated components and employs astronomical calculations to determine traditional daily prayer times. The devices comprise a GPS receiver for outputting latitude, longitude, and in some embodiments altitude data and/or time data. The devices also comprise a clock and a calendar for outputting time and date information respectively. Thus, in different embodiments the present invention can provide users with information regarding both the timing for the start of each of the daily prayers and the direction of Mecca.

The invention may be embodied as a portable stand-alone device, or it may be integrated with a number of different applications. Any GPS receiver-containing piece of equipment may be adapted to incorporate the present invention. Thus, the invention may be embodied in cellular telephones, PDAs, laptop computers, automobile, boat, or airplane-associated navigation systems, hunting or fishing guides. Preferably the invention is part of a cellular telephone. By cellular telephone it is meant any type of mobile communication device that does not necessitate for operation a link to a traditional wired telephone line. The cellular telephone may communicate via any adopted protocol, such as TDMA, CDMA or third generation protocols. In some embodiments it communicates via a widely used communication protocol such as GSM. These embodiments are attractive because telephone communication features may also be functional in various locations, e.g. on different continents.

The devices are physically made up of connected conventional electronic components, for example manual input devices such as keypads, RAMs, ROMs, GPS receivers and antennas, central processing units, geomagnetic sensors in some embodiments, and one or more signal output communication components that may communicate via or include screen displays, speakers for sound alarms or messages, and/or vibration generators. When the invented prayer time calculating devices are integrated with other applications, the same physical components may be utilized for a variety of additional functions.

A component of the invented devices is a calendar that outputs date information. In different embodiments, the user may enter an initial date, or the date may be synchronized with a calendar associated with a wireless network, such as one associated with a cellular telephone service. The date may be automatically adjusted during travel, i.e. as the devices move across time zones, based on location information from the GPS receiver. The date information from the calendar is supplied to the processor or controller for performing calculations. In some embodiments a Muslim calendar (hijri) is also associated with the invented devices. In these embodiments the Muslim date can be conveyed to interested users.

Another component of the invented devices is a clock that outputs time information. Typically the clock produces present time information, i.e. current time at the location of the device. Like the calendar, time information may be synchronized to a clock associated with a wireless network, such as one associated with a cellular telephone service. Thus, it is not absolutely necessary that the clock or calendar be physically embedded within the portable device containing the GPS receiver. In some embodiments, time may be read from the GPS receiver. Present time information is useful for communications to the user, and in some embodiments for calculating prayer times as described below. The controller produces one or more next prayer times. Such future prayer times may be communicated to the user in some form, which may or may not be related to the present local time. For example, a screen may display a message such as “next prayer time in 1 hour 32 minutes”, or “next prayer time at 7:32 pm”. As the time on the clock matches a calculated next prayer time, the system may output a signal to alert the user that a prayer time has arrived. Time adjustments such as for nonstandard time zones and local daylight savings times may be automatically performed from position and date information, as detailed below.

Another component of the invented devices is a GPS receiver. The GPS receiver produces current latitude and longitude coordinate data, which is used by the controller to calculate prayer times. Additionally, the GPS receiver may produce useful altitude and/or time information. The location information detected with the GPS receiver is conveyed to the controller or processor for the calculations necessary to determine prayer times.

A component of the invented devices is a controller comprising a processor that takes the information made available to it to calculate prayer times. Calculations can be performed according to the following methods.

Two astronomical measures called the declination angle of the sun (D, measured in degrees) and the real time-mean time difference, also known as the equation of time (T, measured in minutes), are determined according to equations (1) and (2) below.

$$\begin{matrix}D = \frac{180}{μ} * \{ 0.006918 - [ 0.399912 * Cos [ β ] ] + [ 0.070257 * Sin [ β ] ] - [ 0.006758 * Cos [ 2 * β ] ] + [ 0.000907 * Sin [ 2 * β ] ] - [ 0.002697 * Cos [ 3 * β ] ] + [ 0.001480 * Sin [ 3 * β ] ] \} ; & ( 1 ) \\ T = 229.18 * \{ 0.000075 + [ 0.001868 * Cos [ β ] ] - [ 0.032077 * Sin [ β ] ] - [ 0.014615 * Cos [ 2 * β ] ] - [ 0.040849 * Sin [ 2 * β ] ] \} ; & ( 2 )\end{matrix}$$

wherein μ is the constant π (i.e. approximately 3.141);

$$β = \frac{2 μ ( J )}{365} , \qquad ( 3 )$$

(also known as the year angle); and J is the day of the year, such that for Jan 01 J=0, for Jan 31 J=30, for Feb 1 J=31, and so on.

Prayer times can be calculated according to table I.

TABLE I

| | | | |
|---|---|---|---|
| [symbol] | fajr or subh | Dawn = | Z − Vd |
| [symbol] | zuhr | Noon = | Z |
| [symbol] | asr | Afternoon = | Z + W |
| [symbol] | maghrib | Sunset = | Z + U |
| [symbol] | isha | Dusk = | Z + Vn |

Z, U, V, W, Vd and Vn are hours. They are calculated as shown below.

$$Z = 12 + \frac{R - L}{15} - \frac{T}{60} \qquad ( 4 )$$

wherein L is the longitude and R is the reference longitude, i.e. the longitude from which the time zone is based. Typically, R=15*TZ (Degrees) wherein TZ is the difference between local time and GMT because basic time zones are 15 Degrees of longitude apart: 360°/24H=15 Degrees/H. However, R may be adjusted if necessary. Such necessity may arise from local use of daylight savings time conventions, which can be determined by the controller from available data, i.e. as a function of date and latitude and longitude coordinates and corresponding tables of daylight savings time conventions. Alternatively, use of a local daylight savings time convention may be manually set. Other type of adjustments may be made for those zones that use nonstandard times, such as for example in part of Australia and India. Additionally, adjustments may be made specifically for the boundaries between time zones that do not run precisely along meridians. The adjustments necessary can be entered into tables of the corresponding latitudes and longitudes and made available to the controller.

$$U = \frac{180}{15 * μ} * ArcCos [ \frac{\begin{matrix}Sin [ ( - 0.8333 - 0.0347 * Sign ( H ) * Abs {( H )}^{0.5} ) * \\ \frac{μ}{180} ] - Sin [ D * \frac{μ}{180} ] * Sin [ B * \frac{μ}{180} ]\end{matrix}}{Cos [ D * \frac{μ}{180} ] * Cos [ B * \frac{μ}{180} ]} ] \qquad ( 5 )$$

wherein B is the latitude, H, in meters, is the altitude above sea level, Abs(H) is the absolute value of H, Sign(H) is the sign of H or H/Abs(H). The GPS receiver may automatically provide an accurate value of H (in addition to B and L). In some embodiments, H may be approximated as any value preferably between 0-3000, for example, 0, 50, 100, 200, 500, 1000, 2000, 3000, but may be as high as 4000 or 5000, or even 10000. Alternatively, H may be manually entered.

$$Vd = \frac{180}{15 * μ} * ArcCos [ \frac{- Sin [ Gd * \frac{μ}{180} ] - Sin [ D * \frac{μ}{180} ] * Sin [ B * \frac{μ}{180} ]}{Cos [ D * \frac{μ}{180} ] * Cos [ B * \frac{μ}{180} ]} ] \qquad ( 6 )$$

wherein Gd is dawn's twilight angle (15°-19°), as explained in more detail below.

$$Vn = \frac{180}{15 * μ} * ArcCos [ \frac{- Sin [ Gn * \frac{μ}{180} ] - Sin [ D * \frac{μ}{180} ] * Sin [ B * \frac{μ}{180} ]}{Cos [ D * \frac{μ}{180} ] * Cos [ B * \frac{μ}{180} ]} ] \qquad ( 7 )$$

wherein Gn is night's Twilight Angle (15°-19°), as explained in more detail below.

$$W = \frac{180}{15 * μ} * ArcCos [ \frac{\begin{matrix}Sin [ Arc Cot [ Sh + Tan [ Abs ( B - D ) * \frac{μ}{180} ] ] ] \\ - Sin [ D * \frac{μ}{180} ] * Sin [ B * \frac{μ}{180} ]\end{matrix}}{Cos [ D * \frac{μ}{180} ] * Cos [ B * \frac{μ}{180} ]} ] \qquad ( 8 )$$

wherein Sh=1 for Shafii and Sh=2 for Hanafi. According to the Shafii school of jurisprudence, Asr begins when the length of the shadow of an object exceeds the length of the object. According to the Hanafi School of jurisprudence, Asr begins when the length of the shadow exceeds twice the length of the object. In both cases, the minimum length of shadow (which occurs when the sun passes the meridian) is subtracted from the length of the shadow before comparing it with the length of the object. In some embodiments Shafii or Hanafi may be set or reset by users as a preference, while in other embodiments these values are preset for any device.

In modern times astronomical, rather than civil or nautical, twilight corresponding to solar depressions of 18 degrees have been mainly used (Gd and Gn). However, different conventions may be used in various parts of the world, and the invented devices may be configured to calculate according to any one specific convention, or may offer users a choice of a preferred convention. In some embodiments, the convention may be automatically set as a function of longitude and latitude coordinates as directed by a table stored in a memory that is made available to the controller. Conventions used by some Islamic organizations are shown in table II.

TABLE II

| Organization | Fajr | Isha | Region |
|---|---|---|---|
| University of Islamic | 18° | 18° | Pakistan, Bangladesh, part of |
| Sciences, Karachi | | | India, Afganistan |
| ISLAMIC SOCIETY OF | 15° | 15° | USA, CANADA, UK, MOST |
| NORTH AMERICA | | | OF EUROPE |
| (ISNA) | | | |
| World Islamic League | 18° | 17° | Part of Europe, Part of Far East |
| The Saudi Monarchy | 19° | 90′* | Saudi Palace only (*90 minutes |
| | | | after sunset) |
| Egyptian General | 19.5° | 17.5° | Part of Africa, Syria, Iraq, |
| Organization of | | | Lebanon, Malaysia |
| Surveying | | | |

Some embodiments may also work by incorporating or may be configured to accept information theologically acceptable conventions used for determining prayer times at extreme latitudes.

The invented devices may also calculate and indicate qibla for users. The following equation can be used.

$$Q = \frac{180}{μ} * Arc Tan [ \frac{Sin [ ( LM - L ) * \frac{μ}{118} ]}{Cos [ B * \frac{μ}{180} ] * Tan [ BM * \frac{μ}{180} ] - Sin [ B * \frac{μ}{180} ] * Cos [ ( LM - L ) * \frac{μ}{180} ]} ] \qquad ( 9 )$$

wherein Qibla=Q, and if Q<0 then Qibla=Q+180 (East of North), and if L>LM then Qibla=Q+180 (East of North). BM is the latitude of Mecca (21.27 degree north) and LM is the longitude of Mecca (39.49 degree east).

In some embodiments qibla is communicated to users as a number, and users are then responsible for finding the proper direction. In other embodiments a compass may be included with the devices for the convenience of the users. In other embodiments a geomagnetic sensor produces azimuth information. Then, bearings may be shown on a display. Alternatively, azimuth information may be made available to the controller, and the controller can point to the exact direction of Mecca. Communication may take any of a range of possibilities. For example, an arrow may be displayed on the screen when in a horizontal position, the arrow pointing towards Mecca. Qibla may be determined automatically after as a prayer time comes up, and/or it may be determined on demand by a request entered by the user.

Thus, in calculating prayer times, the controller may also take into account preferences set by a user. The preferences may include any one or more choices or values entered by a user, such as Shafii or Hanafi, or conventions of a particular Islamic organization.

Calculations are preferably performed automatically at preset intervals, although they may be performed or renewed on demand. The frequency of calculations may vary considerably, from minutes to hours to days. In some embodiments, re-calculation of prayer times is triggered automatically when the GPS receiver detects a significant change in location of the device since the last calculation.

The calculated prayer times are communicated to users via a data output. An output may be merely a communication port into which compatible devices may be plugged to receive the information. More typically, the output is a screen capable of displaying written and often graphical information. The output may also or alternatively be a speaker. In many embodiments, next prayer times are communicated relative to the present local times. The same output or a different output may also communicate the direction of Mecca to users.

When the present local time matches a calculated prayer time, an alarm is typically triggered to alert the user of the time to pray. The alarm may be communicated by any means, and may comprise a characteristic sound and/or the device may vibrate. In a preferred embodiment, the alarm comprises the sound of a traditional call to prayer (adhan). Accordingly, a memory stored audio file is retrieved and played. In those embodiments where the invention is combined with other applications, features of other applications may be inactivated for a preset period following the alarm. For example, a cellular telephone may be silenced for a period of religious service.

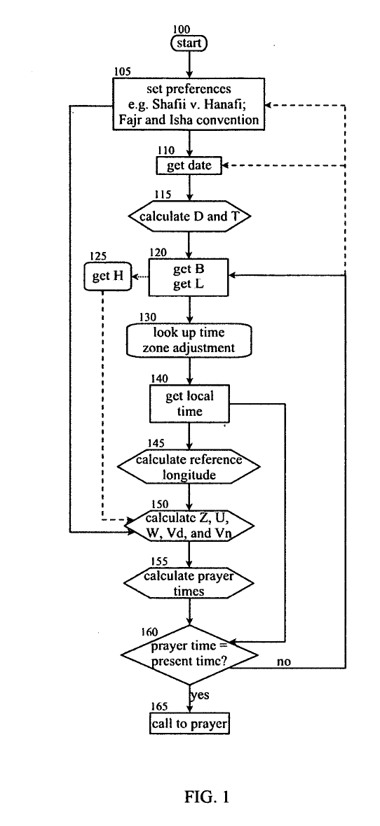

In operation, as depicted in FIG. 1, a user starts (100) by entering personal preferences (105) that the invented devices take into account in performing the calculations. Once set, the preferences may be stored in a memory, and then possibly reset when desired. Then, the calendar supplies the date (110). The values of D and T can then be calculated (115). The GPS receiver automatically generates values of the latitude and longitude (120) and possibly altitude (125) of the device. Based on latitude and longitude as well as date information, the system may look up (130) whether any local time adjustments are necessary. A clock then supplies a local time (140). Based on the longitude, the local time and possibly any time adjustments, the system calculates a reference longitude (145). At this point all the necessary information is available for the calculation (150 and 155) of the prayer times for that day. Thus, from the next prayer time is known by reference to the local time. When the present time matches a prayer time (160), an alarm (165) alerts the user that the prayer time has arrived. Otherwise, the system may recalculate prayer times from position information. The date or preferences may also be adjusted.

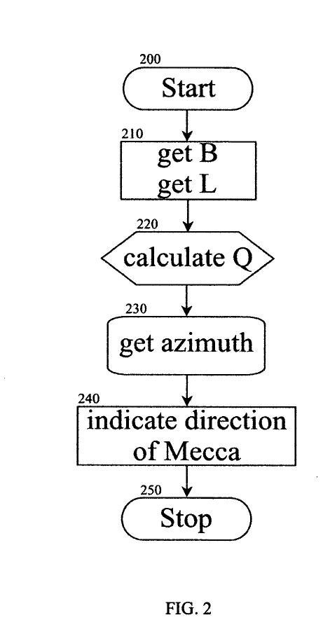

In some embodiments the system also determines the direction of Mecca (FIG. 2). The process may begin (200) either at user's request or automatically as a prayer time arrives. The GPS receiver automatically obtains latitude and longitude coordinates (210). From these, qibla is calculated (220). In some embodiments, azimuth information is also obtained (230), and the direction of Mecca is indicated to the user (240).

In some aspects the invention is directed to computer readable media that comprises data such as programs which can be executed by a processor to automatically perform the calculations and work essentially as the methods described herein.

The invention provides several advantages compared to current related technologies, although all advantages are not necessarily present in every embodiment of the invention. The invention is user friendly and conveys information regarding Muslim prayer times that is quite accurately determined. Timing determination is very precise and can be adjusted essentially instantaneously to situations in which accurate prayer times could not be calculated otherwise. For example, in some embodiments unusual altitudes such as those experienced during air travel are automatically detected and taken into account in determining traditional prayer times. Common use of the invention, even outside a traveling context, can reduce planning efforts and instill users with considerable peace of mind as they are prompted of the arrival of prayer times, can immediately find out the next prayer time, and can ascertain qibla in unfamiliar locations. The invention may be conveniently integrated with a number of devices equipped with GPS receivers, such as cellular telephones.

All cited documents, including patents, patent applications, and other publications are incorporated herein by reference in their entirety.

Foregoing described embodiments of the invention are provided as illustrations and descriptions. They are not intended to limit the invention to the precise form described. Other variations and embodiments are possible in light of above teachings, and it is thus intended that the scope of invention not be limited by this Detailed Description, but rather by the following claims.

1. A portable device for determining prayer times for Muslim religious services, the device comprising:
a calendar for producing date information,
a clock for producing present time information,
a GPS detector for producing a longitude coordinate and a latitude coordinate,
a controller, wherein the controller calculates a next prayer time from the date information, the latitude coordinate, and the longitude coordinate, and
an output for communicating the next prayer time.

2. The device according to claim 1 further comprising an alarm for producing a prayer time signal when the present time matches the next prayer time.

3. The device according to claim 2 wherein the alarm comprises adhan.

4. The device according to claim 1 wherein the GPS detector produces altitude information, and the controller calculates the next prayer time additionally from the altitude information.

5. The device according to claim 1 wherein the controller calculates a direction of Mecca from the longitude coordinate and the latitude coordinate, and further comprising an output for communicating the direction of Mecca to a user.

6. The device according to claim 5 further comprising a geomagnetic sensor for producing azimuth information, wherein the output communicates the direction of Mecca relative to the azimuth information.

7. The device according to claim 1 wherein the device is a cellular telephone.

8. The device according to claim 7 wherein the cellular telephone communicates via the GSM protocol.

9. The device according to claim 7 wherein telephone features are disabled for a time period after the prayer time signal is produced.

10. The device according to claim 1 further comprising an input for entering user preferences, and wherein the controller calculates the next prayer time additionally from user preferences.

11. The device according to claim 1 further comprising a Muslim calendar coupled to the output.

12. A method of automatically calculating Muslim religious service times, the method comprising:
automatically acquiring a latitude coordinate and a longitude coordinate,
automatically acquiring a present date,
computing prayer times based on the latitude coordinate, the longitude coordinate, and the date, and
communicating the prayer times.

13. The method according to claim 12 further comprising automatically acquiring altitude information, and wherein computing prayer times is based additionally on the altitude information.

14. The method according to claim 12 further comprising automatically acquiring a present local time, and wherein communicating the prayer times is relative to the present local time.

15. The method according to claim 14 wherein present date and present local time are acquired by synchronization to a wireless network.

16. A computer-readable media comprising a program implementing the method according to claim 12.
